(19) United States
(12) Patent Application Publication
(10) Pub. No.: US 2026/0280471 A1
(43) Pub. Date: Sep. 17, 2026

(54) Flexible Hinge for Preloading a Mechanical Joint

(71) Applicant: Southwest Research Institute, San Antonio, TX (US)

(72) Inventors: Toby Justin Harvey, Enoch, UT (US); Thomas Jeffrey Harvey, Nederland, CO (US); Ryan James Rickerson, San Antonio, TX (US); Alan John Waclawczyk, Bulverde, TX (US)

(21) Appl. No.: 19/078,380

(22) Filed: Mar. 13, 2025

(51) Int. Cl. H02S 20/30; F16C 11/04

(52) U.S. Cl. CPC H02S 20/30; F16C 11/04

(57) ABSTRACT

A rocker arm hinge for use between segments of a structure that deploys from a folded state to an unfolded state. In one embodiment, the hinge is used between adjacent solar panels of a solar panel array. A rocker arm is attached to a first solar panel near its associated interface via a pivot attachment, the rocker arm having an angled interface end and tail end, the rocker arm operable to pivot about the pivot attachment. A fixed arm is attached to a second solar panel near its associated interface. The rocker arm and the fixed arm together form a triangular configuration, attached together with a pivot shaft at an apex and spaced such that contact will occur between interfaces. A spring is against the tail end of the rocker arm, configured such that the tail end compresses the spring in the unfolded state.

### BACKGROUND OF THE INVENTION

“Stiffness” is the capacity of a mechanical system to sustain external loads without excessive changes of its geometry. For a structure to have and maintain stiffness, all stiffness elements must have zero slop or motion regardless of the forces or direction of force.

An example of a structure that might require stiffness for certain applications is segmented structure with one or more hinged joints between segments. If a conventional hinge with a shaft is used, the joint cannot be allowed to move back and forth due to sloppy fitment of the shaft and holes, even as the load changes from compression to tension across the hinge.

### BRIEF DESCRIPTION OF DRAWINGS

FIGS. 1 and 2 illustrate an example of a deployable hinged structure having a hinge in accordance with the invention.

FIG. 3 illustrates the hinge with a structure in an unfolded (deployed) state with the hinge “open”.

FIG. 4 is a perspective view of the hinge, illustrating the hinge when the structure (not shown) is in a partially folded state.

FIGS. 5-7 illustrate the operation of the hinge as the structure (not shown) moves to full deployment.

FIGS. 8 and 9 illustrate how compliance features of the hinge allow it to be preloaded through a range of angles.

FIG. 10 illustrates the hinge used with a deployable structure having multiple segments and folds.

FIG. 11 illustrates a solar panel array with both front-side and back-side hinges.

FIGS. 12-14 illustrate the hinge used for the front-to-front folds of the structure.

### DETAILED DESCRIPTION OF THE INVENTION

A principle of the hinge described herein is that it will preload a mechanical joint of a structure and bias segments of the structure in one direction at a load that exceeds what the joint will see in the opposite direction, by applying more compression across the joint than the tension force that will apply to it. This will maintain contact of segments and prevent them from unseating or gapping and thus maintain a stiff structure.

In accordance with the above goal, the following description is directed to a hinge for a mast, panel array, or other structure that has at least one hinge joint and is deployable from a folded state to an elongated state. For purposes of this description, such a structure is referred to herein as a “deployable hinged structure”. The structure may be long and narrow, such as a mast, or it may be panel-like as in the solar panel array used as an example in this description, or it may have some other geometry. “Deployable hinged structure” is used herein in a broad sense to mean any hinged structure with two or more segments, with adjoining segments having hinged interfaces such that the structure may fold or unfold from one position to another, regardless of how the deployment is actuated.

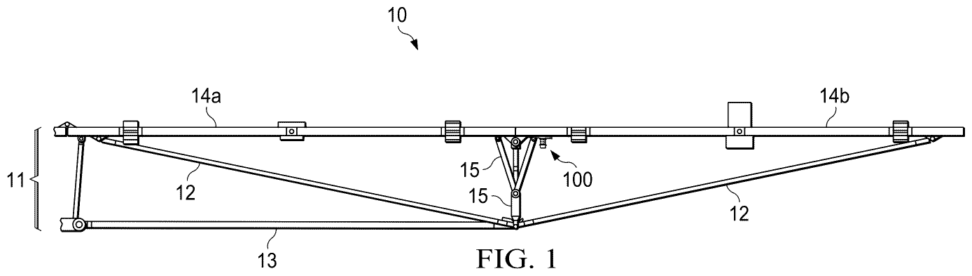

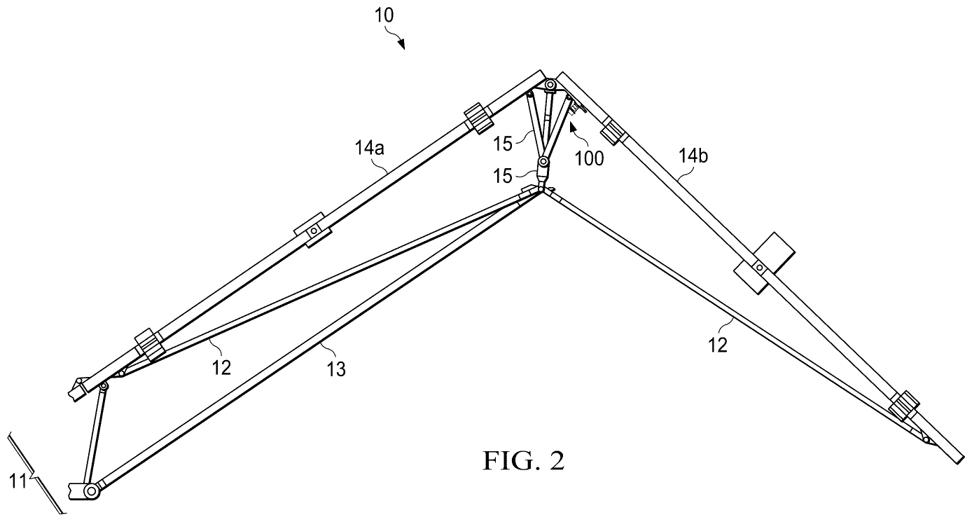

FIGS. 1 and 2 illustrate an example of a deployable hinged structure 10 having a hinge 100 in accordance with the invention. Both FIGS. 1 and 2 are side views of structure 10, which in the example of this description is a deployable solar panel array for use in space. In this example, structure 10 has two segments, a left segment (solar panel 14a) and a right segment (solar panel 14b). These segments abut above hinge 100 at their interfaces.

In FIG. 1 structure 10 is in its deployed (stiff) state. FIG. 2 illustrates structure 10 partially folded (undeployed). Depending on the application and desired amount of folding, hinge 100 may allow the further folding and the two segments may become folded against each other.

Hinge 100 connects the two segments (solar panels) and allows structure 10 to be deployed from a folded state to a deployed (stiff) state. As explained below, hinge 100 may be directly attached to the structure segments or may be attached via a hinge housing.

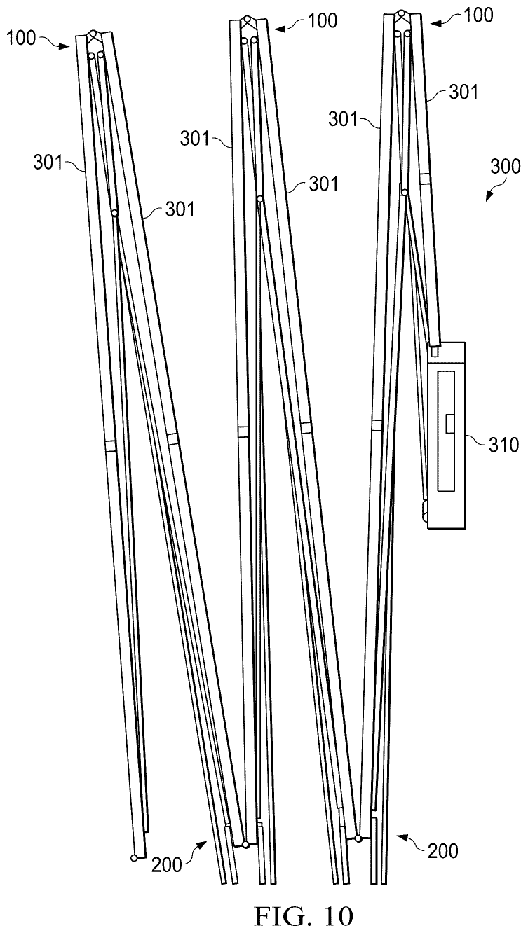

For this solar panel application of hinge 100, the solar panel array (structure 10) has a trussed backing 11 that deploys with the solar panels and supports them after deployment. A solar panel array having additional panels extending from a base point of deployment is described below in connection with FIGS. 10-14. The trussed backing 11 is implemented with spring-like diagonals 12 and longerons 13. Linkages 15 support and enable deployment for the trussed backing 11.

Examples of structures for which hinge 100 is suited are described in U.S. Pat. No. 11,799,414 and U.S. application No. 18/474149, which describe the use of a truss backing and hinges to deploy a solar panel array. Another example of a structure for which hinge 100 is suitable is the deployable mast described in U.S. application Ser. No. 18/333,168, which uses hinges to deploy a trussed mast.

For a deployable hinged structure, multiple segments (such as solar panels) must rotate during deployment and at the end of motion must become preloaded. Conventional preloaded hinges have no compliance because they preload against a hard stop, setting the “open” angle of the hinge to a specific spot. Because a deployable structure has multiple segments in three-dimensional space that must all be preloaded simultaneously, joints between segments must have a level of compliance where they will become preloaded but can still allow some movement due to tolerance stack up, length changes due to thermal variations, and other variables. Each segment must become preloaded, but if the preloading stops the motion of other segments and prevents them from also preloading, the structure will not fully develop and will not become stiff. For example, if the right-side diagonal 12 is a bit too long then the right-side panel 14b must be allowed to over-rotate so its associated diagonal 12 can become tensioned. Thus, hinge 100 must be preloaded but also allow compliance for that over-rotation.

It is also preferable that the preloaded contact points are between the large and stiff elements, such as panels 14a/14b. If a conventional hinge having preloading of its two halves and a shaft between were used, the stiffness path is not ideal as compared to butting the larger structural elements together directly.

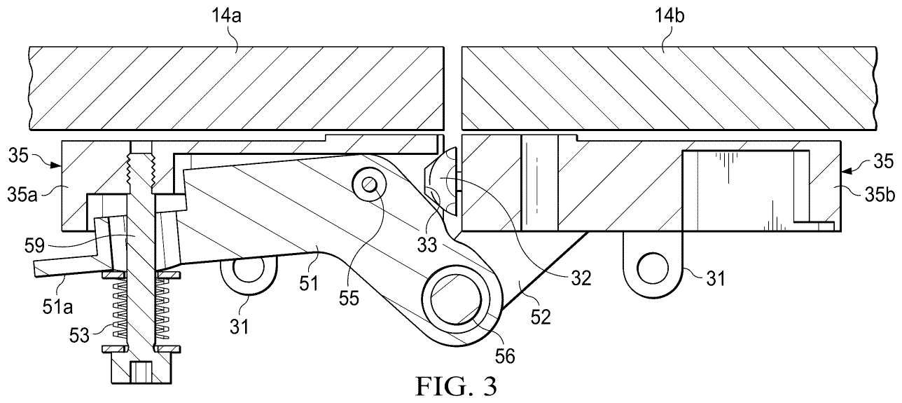

FIG. 3 illustrates structure 10 with hinge 100 in an “open” (deployed) state. Hinge 100 is designed to both become preloaded and remain rotationally free (compliant). More specifically, hinge 100 has a rocker arm 51, which is spring-loaded. As explained below, rocker arm 51 allows hinge 100 to flex into position when deployed, and that resulting motion preloads the joint between panels 14a/14b together. It should be understood that the same concepts apply regardless of whether the “joint” is between rectangular panels, such as solar panels, or between segments of some other structure, such as a mast, desired to be deployed into an elongated stiff state.

In the example of FIGS. 1-9, where hinge 100 is used for a “back-to-back” fold of a trussed solar array, hinge 100 has a housing comprising two halves 35a/35b, which are somewhat analogous to “leaves” of a conventional hinge. Each half 35a/35b of this housing is attached to an associated solar panel (segment) of the structure 10. Each housing half 35a/35b is configured for attachment at an associated interface end of the segment, such that these interface ends will abut or nearly abut when the structure 10 is deployed.

In the embodiment of FIG. 3, the attachment of hinge 100 is to the backs of the two solar panels 14a/14b, to which the truss backing 11 of FIGS. 1 and 2 is also attached. In this “back-to-back” folding configuration of hinge 100, it may have attachment locations 31 for linkages 15 of the truss backing 11.

In the example of FIG. 3, the abutting interfaces of the two halves 35a/35b of the hinge housing have a cup/cone feature, with an extruding cup 32 at the end of one half and a recessed cone 33 at the end of the other. Cup 32 fits into cone 33 in this deployed state. Cup 32 is rounded as is cone 33. The rounding is in the two dimensions shown in FIG. 3 and may also be three-dimensional. This cup/cone configuration provides a point/area of contact between the interfacing edges of solar panels 14a/14b, with this contact beginning near the end of deployment in the manner described below.

The working elements of hinge 100 are primarily rocker arm 51 and its spring 53 and a fixed arm 52. At an end of each of these arms 51 and 52, they are pivotally connected with a pivot shaft 56. More specifically, the rocker arm 51 is attached to the underside of one housing half 35a and the fixed arm 52 is attached to the underside of the other housing half 35b. The rocker arm 51 and fixed arm 52 have a triangular configuration extending outwardly from the solar panels, joined at the apex by pivot shaft 56. In this embodiment, pivot shaft 56 and apex are centered between the interfaces of the panels.

As implied by its name, rocker arm 51 has a rotational feature, and has an angular shape that pivots around a rocker arm pivot 55. Spring 53 is secured against rocker arm 51 at an end of rocker arm distal to the pivot shaft 56. The rocker tail 51a of rocker arm is between spring 53 and housing 35. As explained below, spring 53 compresses near the end of deployment of hinge 100. A bolt 59 passes through both spring 53 and rocker tail 51a, attaching them to the underside of the associated housing half 35a.

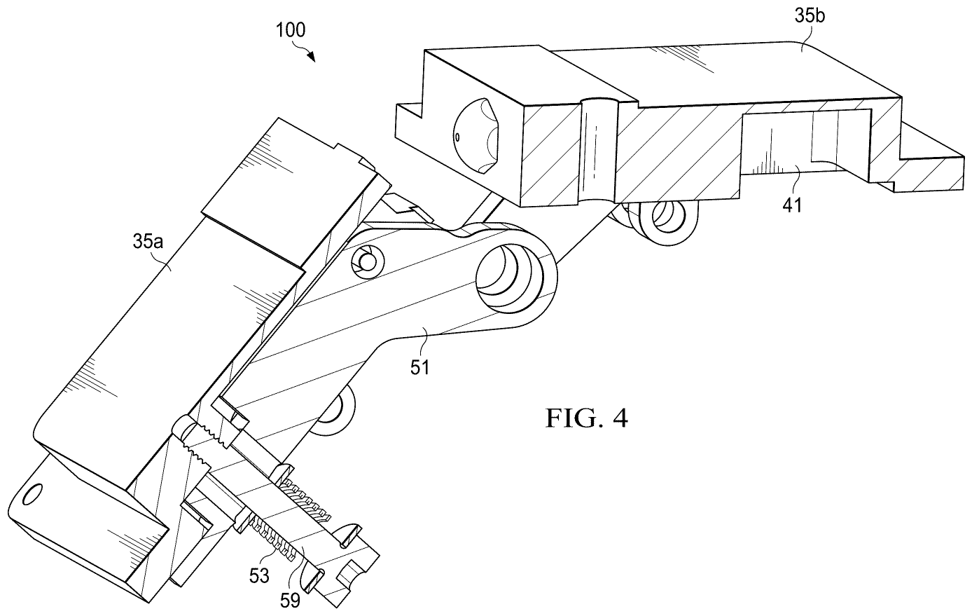

FIG. 4 is a perspective view of hinge 100 and illustrates hinge 100 when structure 10 is in partially folded state. Rocker arm 51 is preloaded against its associated housing half 35a, and the hinge/housing assembly may open and close. Design features such as a recess 41 in housing half 35b to accommodate spring 53 may be used.

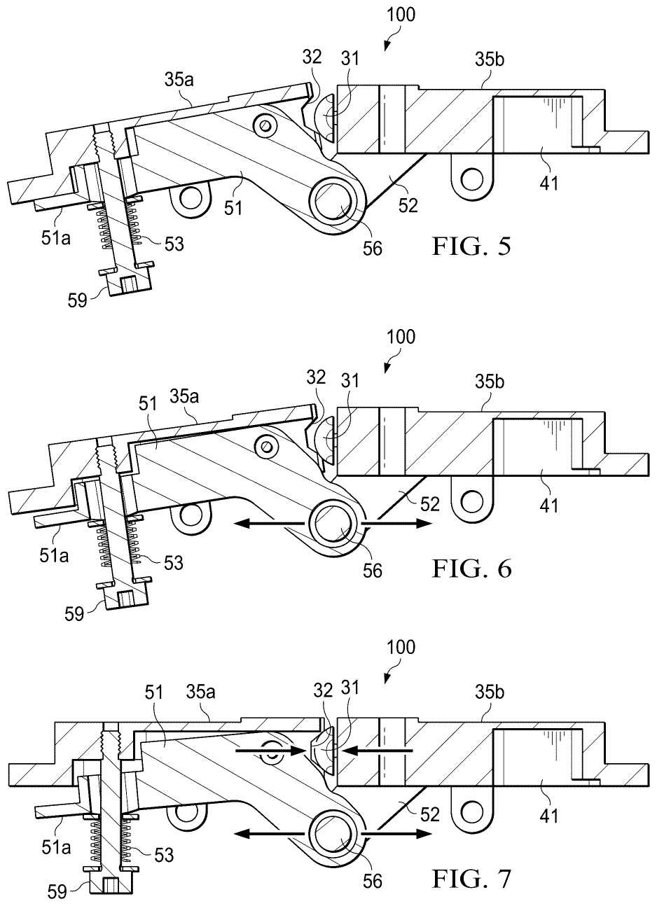

FIGS. 5-7 illustrate the operation of hinge 100 as the structure (not shown) with its attached hinge 100 moves to full deployment. In FIG. 5, once the structure nears full deployment, cup 32 and cone 33 begin to contact. The hinge rotation axis changes from the pivot shaft 56 to the cup/cone contact area. Tail 51a of rocker arm 51 moves in response to the motion of rocker arm 51 and will eventually compress spring 53.

As deployment continues and the hinge 100 pivots about the cup/cone contact area, rocker arm 51, pivot shaft 56, and fixed arm 52 are pulled in tension. On a conventional hinge with a hard stop and no rocker arm 51, the cup/cone contact would be a hard stop and prevent further motion of hinge 100. However, with rocker arm 51, hinge 100 may continue rotating after the cup/cone have seated.

Tension and motion across the rocker arm 51 and fixed arm 52 are a result of the rocker arm 51 and compression spring 53. In the deployed state, tension across pivot shaft 56 is equally countered by compression exerted on the cup/cone area.

In the examples of this description, the contact point as the two structure segments deploy is the above-described cup/cone contact point. However, other forms of contact points or areas along the hinge line interfaces are possible, with the contact points or areas being pulled together by tension across pivot shaft 56.

Design choices such as joint motion once preloaded, maximum preload force, minimum preload force, preload spring rate, length of preload motion, and others can be adjusted by changing the geometry to fine tune the hinge characteristics.

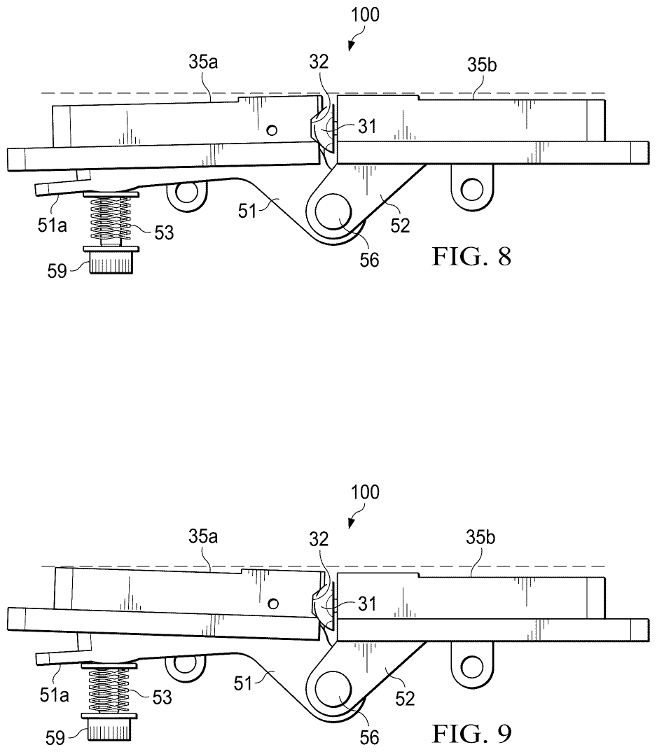

FIGS. 8 and 9 illustrate how compliance features of hinge 100 allow the contact area, here illustrated as a cup/cone contact area, to be preloaded through a range of angles which can result from tolerance and fitment variance of structure 10. FIG. 8 illustrates an underextended deployment of structure 10. FIG. 9 illustrates a hyper extended deployment of structure 10.

FIG. 10 is a side view of a solar panel array 300 having multiple segments (solar panels) that fold and unfold (deploy) and further illustrates how rocker arm hinges using the same basic design as hinge 100 can be used for such structures. Multiple solar panels 301 are folded accordion-like in an undeployed state. Like the solar panel array of FIGS. 1 and 2, solar panels 301 each have a front side, which is the side having solar cells, and a back side, to which a truss support structure is attached. A hinged base segment 310 may also be part of the structure.

In this multi-panel array 300, the hinges 100/200 may be for either the “back-to-back” folds, such as hinges 100 described above, or for “front-to-front” folds, such as hinges 200, depending upon which side of a fold they are located. In either case, the hinges 100/200 allow panel interfaces to become abut and provides stiffness to the structure with a desired amount of compliance as described above.

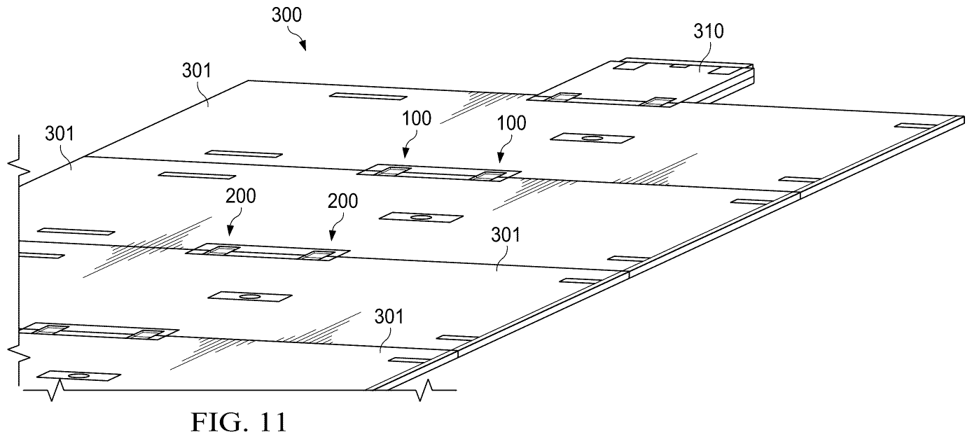

FIG. 11 is a perspective view of solar panel array 300. Because solar panels 301 are rectangular in shape, more than one hinge 100/200 may be used along the hinge lines between panels. Each panel 301 has an interface to this hinge line, which in the example of this description is a squared edge.

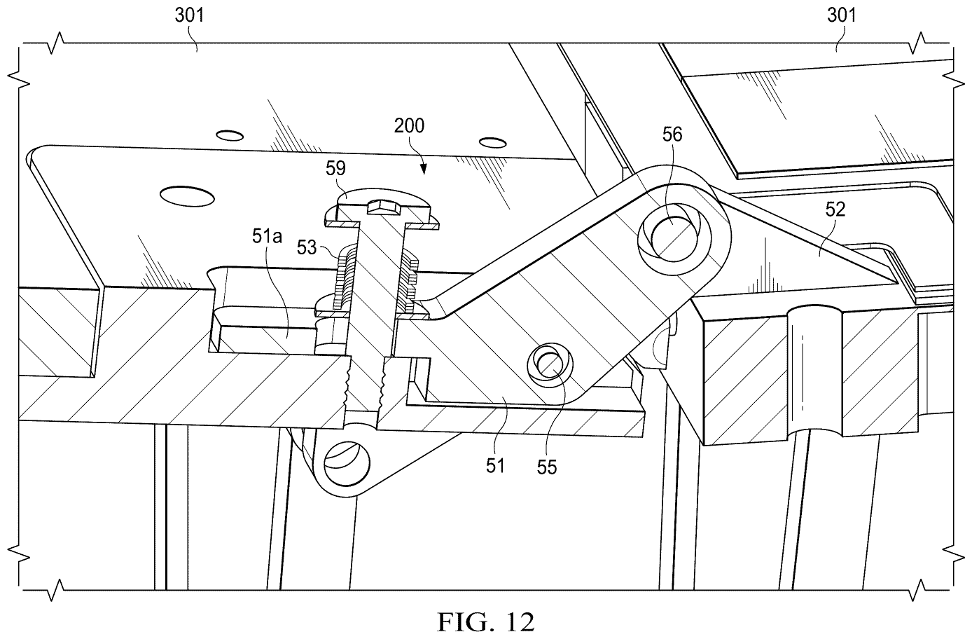

FIGS. 12-14 illustrate a hinge 200 used for a “front-to-front” fold. Hinge 200 has the same working elements and operation as hinge 100 but is “upside down” relative to hinges 100. Hinge 200 may be affixed to the solar panels (or other structure segments) without the housing described above for hinge 100. Like hinge 100, hinge 200 has a spring-loaded rocker arm 51 and a fixed arm 52 having a triangular configuration connected to each other by a pivot shaft 56. For hinge 200, the apex and pivot shaft 56 and spring 59 extend from the “active” (solar collection) side of the solar panels rather than from the underside.

As the structure deploys, the hinge rotation axis changes from pivot shaft 56 to a point of contact along the hinge line. In the embodiment of FIGS. 12-14, this point of contact is a cup/cone as described above but other geometries for a point or area of contact between segment interfaces are possible. As deployment continues, rocker arm 51 and fixed arm 52 are pulled in tension. However, rather than a hard stop, the rocker arm's compliance allows the hinge to continue rotating, with tension across rocker arm 51 being countered by the action of spring 53.

In FIG. 12, a perspective view of hinge 200, rocker arm 51 is attached to one panel 301 and fixed arm 52 is attached to an adjacent panel 301. They are connected to each other at pivot shaft 56. Rocker arm may pivot around pivot 55, which is its attachment point to its associated panel 301. Rocker arm 51 has a spring 53 that preloads rocker arm 51 into a “fixed” state when the structure is stowed and during deployment. A tail 51a of rocker arm sits flush with panel 301 in this state.

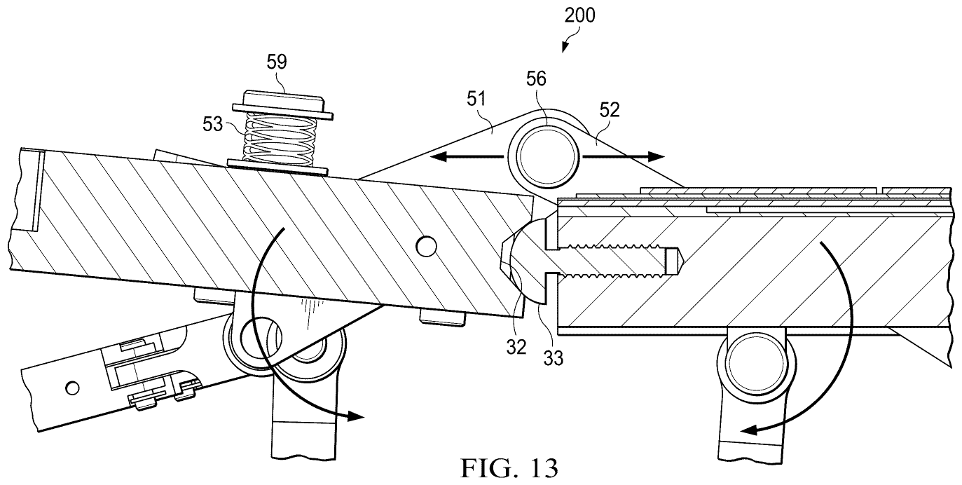

FIG. 13 is a side view of hinge 200 toward the end of deployment. In this example, like the example above, the solar panel interfaces have a cup/cone interface, with a “cup” 32 on the interface of one panel and a “cone” 33 on the interface of the other. The cup/cone interface described herein provides a controlled contact point. However, as previously stated, hinges 100 and 200 may operate with a variety of interfaces that provide a point or area of contact along the hinge line between panels 301.

When the structure reaches the end of deployment, the cup 32 and cone 33 seat and the two panels 301 now shift from pivoting around the hinge shaft 56 to pivoting around the cup/cone that is seated. As indicated by the arrows, this rotation around the cup/cone tries to pull across the pivot shaft 56 to the fixed arm 52, such that the rocker arm/fixed arm are in tension (arrows pulling apart).

The goal of deployment is to seat all panel interfaces together. This is because if the interfaces have slop at the end of deployment, there is structural deficiency. However, when the cup/cone seats, hinge 200 can “flex” as rocker arm 51 rotates and compresses spring 53. Hinge 200 is designed for a certain amount of motion of rocker arm 51 when the panels 301 are in their deployed position; the cup/cone seats a couple degrees before the end of deployment.

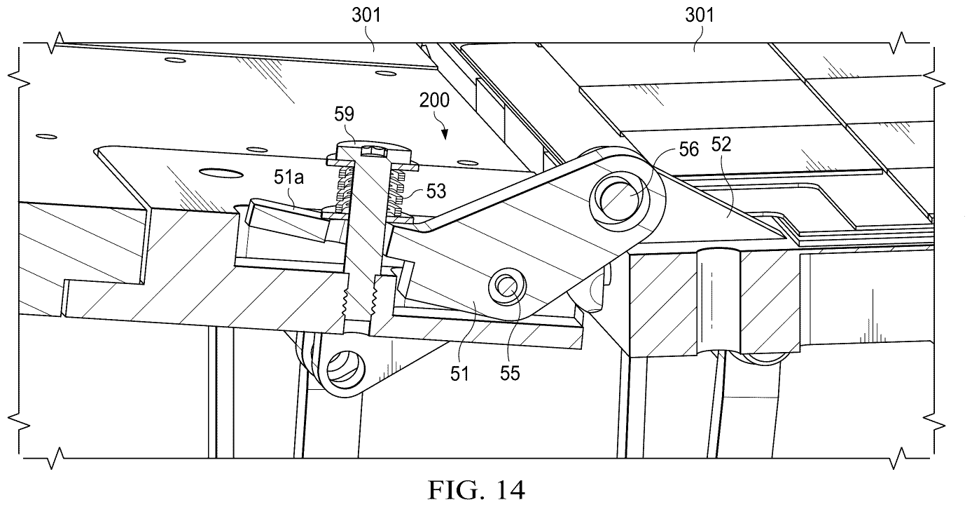

FIG. 14 is a perspective view of hinge 200 when the structure is fully deployed. With the structure fully deployed, spring 53 is compressed, so rocker arm 51 is trying to rotate counterclockwise and is trying to pull the adjacent panel 301 towards it. That force is adjusted so that the cup/cone will always be seated. As a result, there is no slop between the two panels 301 because the tension across the panels would have to exceed the tension from rocker arm 51 to allow the cup/cone contact to gap and create slop.

Referring to the two main embodiments explicitly illustrated herein (hinge 100 and hinge 200), such as in FIGS. 3 and 12 for example, the pivot shaft 56 and “apex” of the triangle formed by the rocker arm 51 and fixed arm 52, are centered between the interfaces of the associated panels. However, this need not be the case. In other embodiments, the apex need not be centered. For example, rocker arm 51 could be longer and fixed arm 52 could be a vertical tab, with pivot shaft 56 being offset from the centerline between panels. This modularity would allow for different hinge geometries.

Furthermore, cone 33 and cup 32 are preferably on the centerline of the panels for an optimal stiffness path, but this is not required. Pivot shaft 56 and cup/cone 32/33 can be located variously depending on requirements. Ultimately, for stowage and during deployment the panel segments are rotating around the axis of the pivot shaft 56, and during final deployment (stiffening of the structure) the pivot location will change to wherever cup cone 33/32 are located, as described above. The cup/cone 32/33 and pivot shaft 56 need not be vertically aligned with each other.

In sum, both hinge 100 and hinge 200 provide the same benefits. They provide preload to a mechanical hinge line by using a spring-loaded rocker arm 51. Conventionally, a hinge line would set the position of two rotating segments, but hinge 100/200 decouples the hinge line location to a pivot point at pivot shaft 56. Further, hinge 100/200 provides a way to preload the final pivot point providing stiffness to the overall mechanical joint.

Hinge 100/200 has other benefits. A desired amount of tolerance is allowed due to an adjustable motion zone so rocker arm 51 can move around and be compliant to alignment issues. Dimensions of spring 53 and rocker arm 51 can be sized to easily and quickly set the stowed/deploying preload of the rocker arm and then the amount of tension across the hinge line. And finally, because hinge 100/200 allows compliance, in the event of the structure being overloaded the hinge line may move and absorb energy and then return back to the deployed shape.

1. A rocker arm hinge for use between segments of a structure that deploys from a folded state to an unfolded state in which adjacent interfaces of the segments abut or nearly abut, comprising:
a rocker arm attached to a first segment near its associated interface via a pivot attachment, the rocker arm having an interface end and a tail end, the rocker arm operable to pivot about the pivot attachment;
a fixed arm attached to a second segment near its associated interface;
wherein the interface end of the rocker arm and the fixed arm together form a triangular configuration with relative positioning that varies during folding and unfolding of the hinge, attached together with a pivot shaft at an apex of the triangular configuration, and spaced such that contact will occur between interfaces;
at least two hinge leaves disposed on both sides of the pivot shaft operable to connect the rocker arm and the fixed arm to the respective segments of the structure;
a spring against the tail end;
wherein the spring and the tail end are configured such that the tail end compresses the spring in the unfolded state; and
a spring compression element configured to counteract he movement of the rocker arm such that the tail end of the rocker arm can compress the spring in the unfolded state.

2. The hinge of claim 1, wherein the contact is implemented with a cup at the interface of the first or second segment and a cone at the interface of the other of the first or second segment.

3. The hinge of claim 1, wherein the apex is centered between the interfaces.

4. The hinge of claim 1, wherein the contact is one or more points along the interfaces.

5. (canceled)

6. canceled

7. canceled

8. A rocker arm hinge for use between segments of a solar panel array that deploys from a folded state to an unfolded state in which the solar panel array is a series of solar panels and adjacent interfaces of solar panels abut or nearly abut, comprising:
a rocker arm attached to a first solar panel near its associated interface via a pivot attachment, the rocker arm having an angled interface end and tail end, the rocker arm operable to pivot about the pivot attachment;
a fixed arm attached to a second solar panel near its associated interface;
wherein the interface end of the rocker arm and the fixed arm together form a triangular configuration with relative positioning that varies during folding and unfolding of the hinge, attached together with a pivot shaft at an apex of the triangular configuration, and spaced such that contact will occur between interfaces;
at least two hinge leaves disposed on both sides of the pivot shaft operable to connect the rocker arm and the fixed arm to the respective segments of the solar panel;
a spring against the tail end;
wherein the spring and the tail end are configured such that the tail end compresses the spring in the unfolded state; and
a spring compression element configured to counteract the movement of the rocker arm such that the tail end of the rocker arm can compress the spring in the unfolded state.

9. (canceled)

10. canceled
